(19) United States
(12) Patent Application Publication
(10) Pub. No.: US 2005/0203956 A1
(43) Pub. Date: Sep. 15, 2005

(54) Systems and methods for facilitate state transitions for managed business objects

(76) Inventors: Jay S. Dweck, Armonk, NY (US); Alexander D. Hassan, Herfordshire (GB)

Correspondence Address: BUCKLEY, MASCHOFF, TALWALKAR LLC, 5 ELM STREET, NEW CANAAN, CT, 06840, US

(21) Appl. No.: 11/075,206

(22) Filed: Mar. 8, 2005

Related U.S. Application Data
(60) Provisional application No. 60/551,499, filed on Mar. 9, 2004.

(51) Int. Cl. G06F 17/00

(52) U.S. Cl. 707/104.1

(57) ABSTRACT

Systems and methods are provided to facilitate state transitions for managed business objects. For example, a managed business object may be created such that it can be in one of a number of pre-defined states. When an event notification is received, an action request is issued to a component application based on (i) the current state of the managed business object, (ii) the event notification, and (iii) a pre-defined rule. An action response is then received from the component application, and the state of the managed business object is transitioned in accordance with the action response.

### CROSS-REFERENCE TO RELATED APPLICATIONS

The present application claims the benefit of U.S. Provisional Application No. 60/551,499 entitled “Systems and Methods to Facilitate State Transitions for Managed Business Objects” and filed Mar. 9, 2004. This application is also related to U.S. patent application Ser. No. ______ entitled “Financial Transaction Modeling System” and filed concurrently herewith. The entire contents of these applications are incorporated herein by reference.

### COPYRIGHT AUTHORIZATION

A portion of the disclosure of the patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The present invention relates to managed business objects. In particular, the present invention relates to systems and methods to facilitate state transitions for managed business objects.

### BACKGROUND

An enterprise may need to track business items. For example, a company may create contracts that must be tracked with respect to dates and/or financial market information. Moreover, the status of each contract may need to be maintained (e.g., a contract might be pending or canceled) and the company may need to respond to different types of events associated with the contract (e.g., a payment amount may need to be calculated and paid on a periodic basis).

Tracking these types of business items can be a difficult task, such as when there are a large number of contracts and/or a large number events associated with the contracts. The task may be even more difficult with respect to contracts that last for an extended period of time (e.g., each contract might have a term of ten years). In addition to the time and expense associated with tracking business items, errors may occur (e.g., a payment amount may be incorrectly calculated) and the errors may require additional work to resolve (if the errors can be resolved at all).

### SUMMARY

To alleviate problems inherent in the prior art, the present invention introduces systems and methods to facilitate state transitions for managed business objects.

In one embodiment of the present invention, a managed business object is created such that it can be in one of a number of pre-defined states. When an event notification is received, an action request is issued to a component application based on (i) a current state of the managed business object, (ii) the event notification, and (iii) a pre-defined rule. An action response is then received from the component application, and the state of the managed business object is transitioned in accordance with the action response.

According to another embodiment, a component application receives an action request from a control engine, the action request being issued by the control engine based on (i) the state of a managed business object, (ii) an event notification received by the control engine, and (iii) a pre-defined rule. An action is then performed in response to the action request, and an action response is transmitted to the control engine after the action is performed.

Another embodiment comprises: means for creating a managed business object associated with a plurality of pre-defined states; means for receiving an event notification; means for issuing an action request to a component application based on (i) a current state of the managed business object, (ii) the event notification, and (iii) a pre-defined rule; means for receiving an action response from the component application; and means for transitioning the state of the managed business object in accordance with the action response.

Still another embodiment comprises: means for receiving at a component application an action request from a control engine, the action request being issued by the control engine based on (i) the state of a managed business object, (ii) an event notification received by the control engine, and (iii) a pre-defined rule; means for performing an action in response to the action request; and means for transmitting an action response to the control engine after the action is performed.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of a system according to some embodiments of the present invention.

FIG. 2 illustrates managed business object states according to some embodiments of the present invention.

FIG. 3 is a flow chart of a control engine method according to some embodiments of the present invention.

FIG. 4 is a flow diagram showing the interactions of component applications with the control engine as well as data that may be stored and communicated.

FIG. 5 is a state view according to some embodiments of the present invention.

FIG. 6 is a tabular representation of a portion of a rule database according to one embodiment of the present invention.

FIG. 7 is an example of state transitions according to one embodiment of the present invention.

FIG. 8 illustrates additional state transitions according to one embodiment of the present invention.

FIG. 9 is a block of a control engine according to some embodiments of the present invention.

FIG. 10 is a block diagram overview of a system according to another embodiment of the present invention.

FIG. 11 is a flow chart of a component application method according to some embodiments of the present invention.

FIG. 12 illustrates an information display according to one embodiment of the present invention.

### DETAILED DESCRIPTION

Some embodiments described herein are associated with “managed business objects.” As used herein, the phrase “managed business object” may refer to any information that represents a business or commercial item. A managed business object might represent, for example, a business abstraction (e.g., a cash flow) or a contract (e.g., associated a long-term obligation or a swap).

System Overview

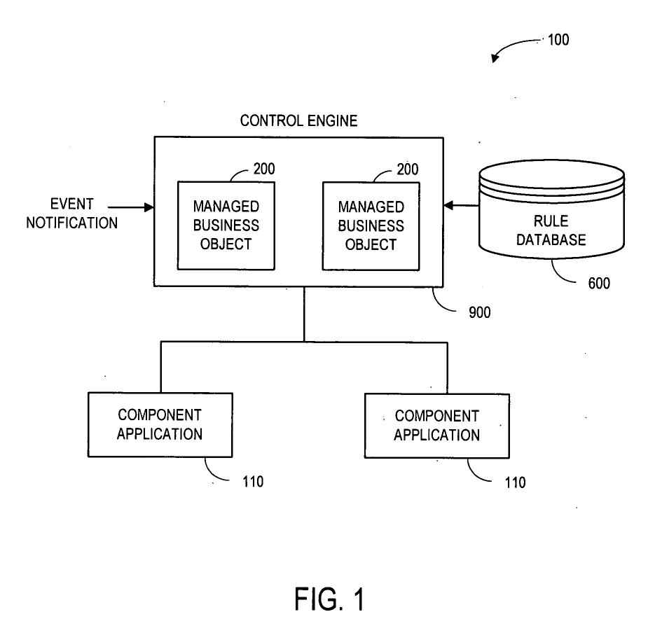

FIG. 1 is a block diagram overview of a system 100 according to some embodiments of the present invention. In particular, a control engine 900 is able to exchange information with one or more component applications 110. The control engine 900 and the component applications 110 may be any devices capable of performing the functions described herein, such as computers, servers, workstations, and networks.

Moreover, the control engine 900 and the component applications 110 may exchange information via one or more communication networks, such as a Local Area Network (LAN), a Metropolitan Area Network (MAN), a Wide Area Network (WAN), a proprietary network, a Public Switched Telephone Network (PSTN), a Wireless Application Protocol (WAP) network, a wireless network, or an Internet Protocol (IP) network such as the Internet, an intranet or an extranet. Note that the control engine 900 might communicate with a one component application 110 via one network and another component application 10 via another network. Moreover, although a single control engine 900 and two component applications 110 are illustrated in FIG. 1, embodiments may include any number of these devices (and a single device might act as both a control engine 900 and a component application 110).

The control engine 900 is responsible for managing a number of different business objects 200. Note that there may be different types of managed business objects 200, and that multiple instances of each type of managed business object may co-exist (e.g., the control engine 900 might currently be managing three contract business objects and ninety cash flow business objects).

Each managed business object 200 can be in one of a number of pre-defined “states.” That is, at any time the managed business object 200 exists in one of a set of states, each state representing some point in the lifecycle of the managed object (e.g., a contract status, cash flow state, or rate fix). The control engine 900 may perform the concomitant (e.g., simultaneously and as a result of) management of the states of a set of such business objects. To facilitate the management of multiple business objects, each instance of a managed business object type may be associated with a identifier, such as a 128-bit identifier that is unique across an enterprise.

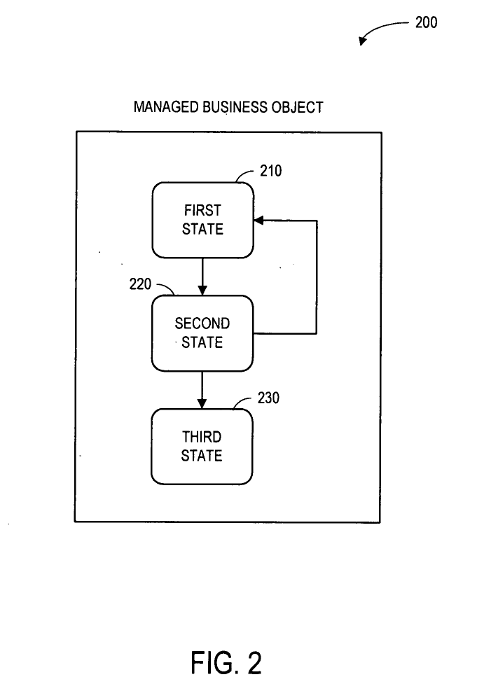

FIG. 2 illustrates a managed business object 200 according to some embodiments of the present invention. In particular, the managed business object 200 can be in a first state 210 (e.g., a “new” state that is entered when the managed business object 200 is created). The control engine 900 may then transition the managed business object 200 out of the first state 210 and into a second state 220. In some cases, the managed business object might enter one of a number of different states when it leaves a particular state. For example, the managed business object 200 illustrated in FIG. 2 can return to the first state 210 or enter a third state 230 when it leaves the second state 220.

Referring again to FIG. 1, the control engine 900 may receive an “event” notification, such as the posting of a real-world event from an external source (e.g., from a market information service). An event notification could also be received from a component application 110. According to some embodiments, events are “irrefutable” (e.g., the system 100 cannot refuse to acknowledge the event) and reflect that some human, time, or data condition has occurred related to a managed business object 200. Note that an event notification might represent an asynchronous event, and that a number of different, potentially competing, event notifications could exist (e.g., one event notification might indicate that an order should be shipped to a customer while another one indicates that the order should be canceled).

As will now be described, the control engine 900 may then adjust the state of a managed business object (e.g., to reflect that a payment has been received) based on the event notification and one or more rules stored in a rule database 600.

Control Engine Method

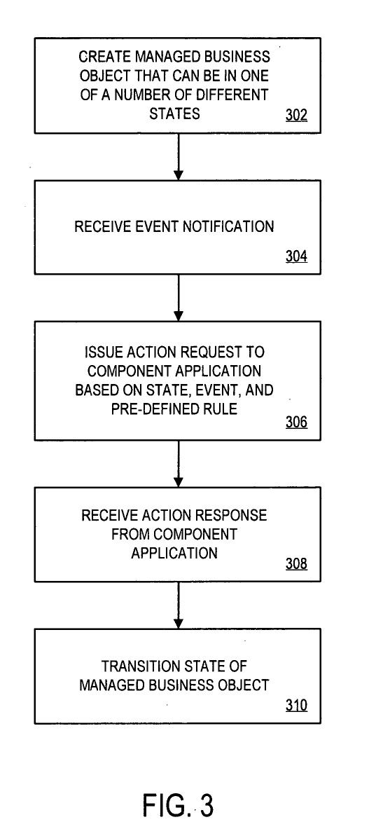

FIG. 3 is a flow chart of a control engine method according to some embodiments of the present invention. The flow charts described herein do not imply a fixed order to the steps, and embodiments of the present invention may be practiced in any order that is practicable.

At 302, a managed business object is created. For example, a user might review a business process and identify a number of business objects associated with that process (e.g., contracts and cash flows). Moreover, each business object is associated with a plurality of pre-defined states (e.g., pending and closed). Information about the managed business object may then be provided to and stored by the control engine 900.

At 304, an event notification is received. For example, the control engine 900 might receive an event notification indicating that a contract will expire in ninety days (e.g., the event notification might be received from a calendaring system).

At 306, an action request is issued to a component application 110 based on (i) the current a state of the managed business object, (ii) the event notification, and/or (iii) a pre-defined rule. The action request may be, for example, a request to the component application 110 asking it to perform some operation relating to a managed object. For example, the control engine 900 might ask a component application to determine the current London Inter-Bank Offered Rate (LIBOR) and re-calculate a payment amount associated with a contract obligation.

At 308, an action response is received from the component application 110 (e.g., indicating that the action has been performed). For example, the component application 110 might send an action response to the control engine 900 indicating that a payment amount has be re-calculated (e.g., and the result might be included in the action response or the component application 110 might have directly updated a shared contract database).

The state of the managed business object is transitioned at 310 in accordance with the action response. For example, the control engine 900 might transition the state of a managed business object from “pending” to “paid.”

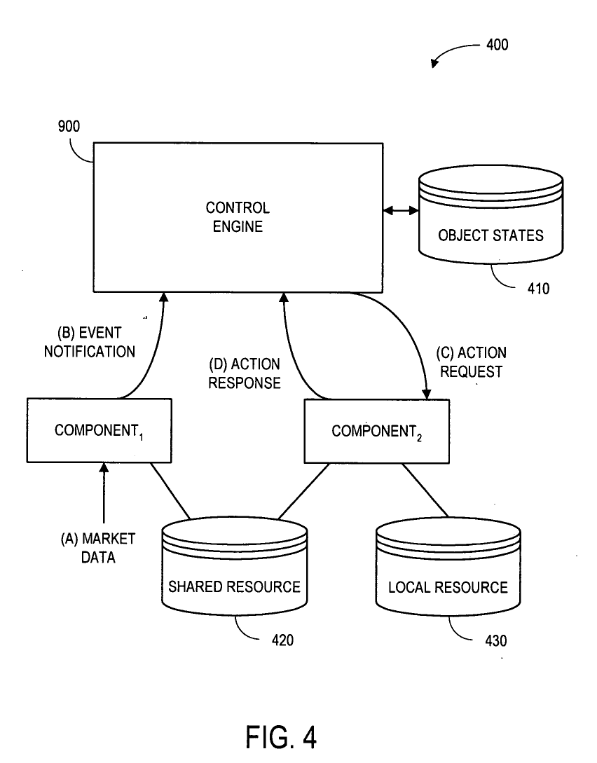

FIG. 4 is a flow diagram 400 showing the interactions of component applications with the control engine 900 as well as data that may be stored and communicated. In this case, the control engine 900 exchanges information with Component₁ and Component₂.

At (A), Component₁ receives market data (e.g., such as by receiving a current stock price from a financial market service). At (B), Component₁, transmits an event notification to the control engine 900 (e.g., indicating that the price of a stock has transitioned past a threshold value).

The control engine 900 manages object states stored in a database 410, and issues an action request to Component₂ (e.g., asking that shares of a stock should be sold) in response to the event notification and the current state of a business object. After the requested action is performed, Component₂ transmits an action response to the control engine 900 at (D). The action response might, for example, indicate that an action has been completed or that an action will not be completed. According to some embodiments, the performance of an action is “guaranteed” (e.g., the action will be completed or an exception will be generated).

The control engine 900 then updates the state of a managed object in the database 410. Note that a shared resource 420 (e.g., a contract database) might be accessible by multiple components while a local resource 430 might be accessible by a single component.

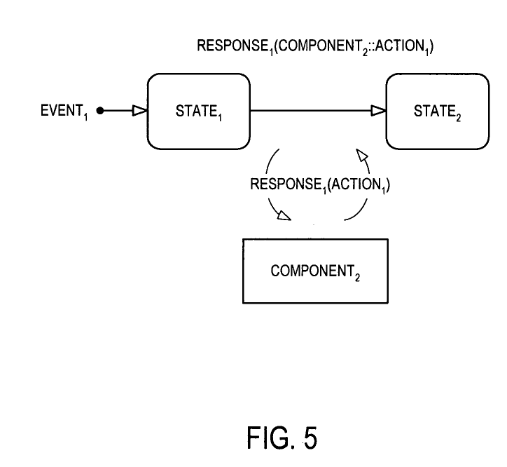

FIG. 5 is a state view according to some embodiments of the present invention. The state view may represent, for example, use cases for a given managed object type. Each case may represent the actions and state transitions that can result from a given event being applied to a given initial state. In particular, FIG. 5 illustrates that a managed business object of this type will always transition from State₁ to State₂ when a Response₁ is received from Compononet₂ indicating that Action₁ has been performed.

Rule Database

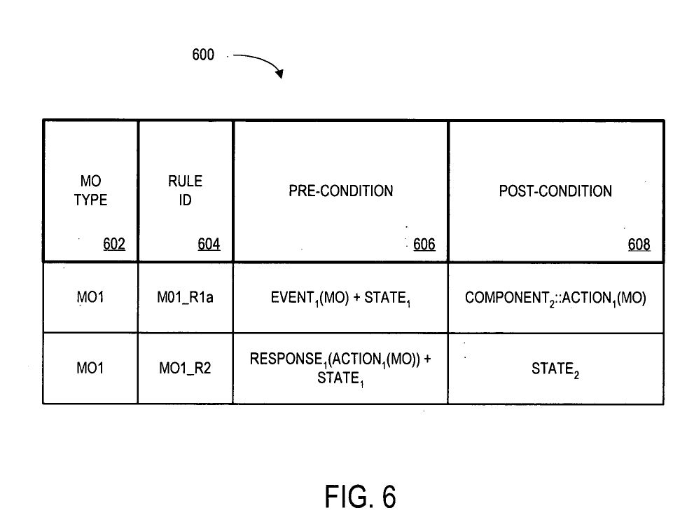

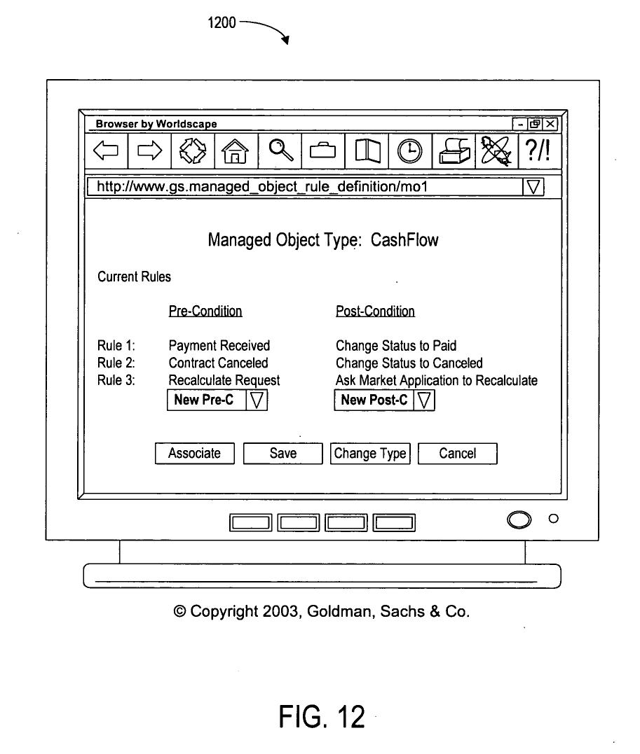

Referring to FIG. 6, a table represents the rule database 600 that may be accessed by the control engine 900 according to an embodiment of the present invention. The table includes entries that define one or more rules. The table also defines fields 602, 604, 606, 608 for each of the entries. The fields specify: a Managed Object (MO) type 602, a rule identifier 604, a pre-condition 606, and a post-condition 608. The information in the rule database 600 may be created and updated based on, for example, information received from a user. According to some embodiments, the user may provide the information via a Graphical User Interface (GUI) such as the one described with respect to FIG. 12.

The managed object type 602 may be, for example, an alphanumeric code associated with a type of business object (e.g., a bond transaction). The rule identifier 604 lets multiple rules be defined for each managed object type. Note that the illustration and accompanying description of this database 600 are exemplary, and any number of other database arrangements could be employed besides those suggested by the figure.

Each rule is associated with a pre-condition 606 defining when the rule is triggered. The pre-condition 606 may be associated with, for example, receiving an event notification, receiving an action response, a managed business object state transition, and/or Boolean operations. The post-condition 608 defines what should happen when the pre-condition is satisfied. The post-condition 608 might be associated with, for example, transitioning a managed business object state and/or issuing an action request.

In some cases, a rule is associated with a receipt of an event notification. For example, if the control engine 900 receives an event notification of type “Event” referencing a managed object of type MO when the managed object is in Stateᵢ, the control engine 900 might issue an action request of type “Action” to component “Componentₓ” referencing that managed object. This rule might be defined as:
Event(MO)+Stateᵢ(MO)→Componentₓ::Action(MO)
The control engine might instead transition the managed object to Stateⱼ:
Event(MO)+Stateᵢ(MO)→Stateⱼ(MO)
According to some embodiments, an event can reference one, and only one, managed object.

In other cases, a rule is associated with a receipt of an action response from a component application. For example, if the control engine 900 receives an action response of type “Response” referencing an action request of type “Action” on a managed object of type MO from Componentₓ, when the managed object is in Stateᵢ, the control engine 900 might transition the managed object to Stateⱼ:
Response(Action(MO))+Stateᵢ(MO)→Stateⱼ(MO)
Note that an action response might be scoped by managed object type, the current state, and the action request type. Moreover, in some embodiments, only a single action response is allowed to be pending for each managed object (e.g., and thus there is no need to identify the responding component).

In still other cases, when the control engine 900 transitions a managed object of type MO to a particular State_{z}, an action request of type Action is issued to Componentₓ referencing the managed object:
State₂(MO)→Componentₓ::Action(MO)
Note that such a rule can be “path-independent” (e.g., the action request is a function of the new state, not of how the new state was reached).

### EXAMPLE

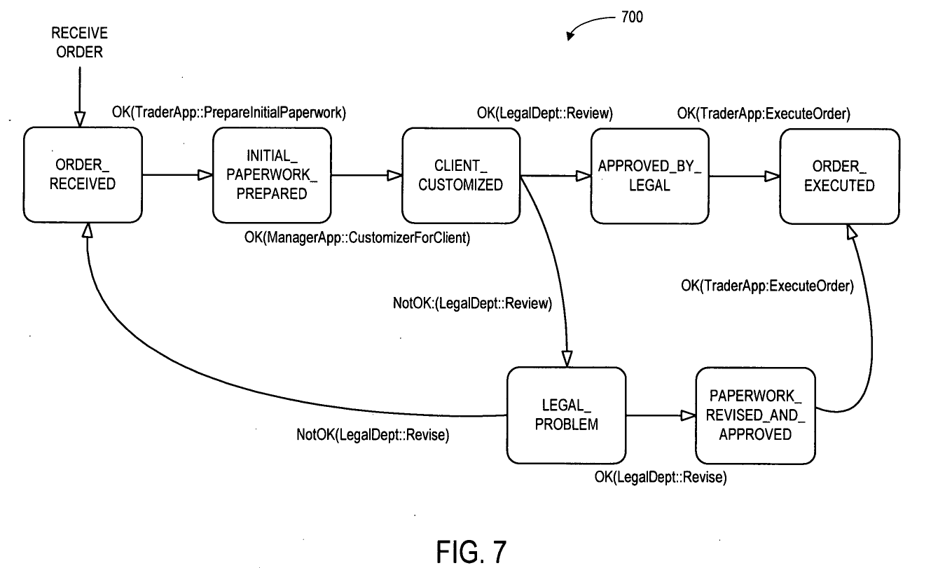

FIG. 7 is an example 700 of state transitions according to one embodiment of the present invention. In particular, when a “Receive Order” event notification occurs, the following rule causes the control engine 900 to establish an instance of a managed business object and place that instance in state “ORDER_RECEIVED”
Receive Order→ORDER_RECEIVED
The following rule indicates that when the state ORDER_RECEIVED is entered, an action request is transmitted to a “TraderApp” component asking the component to prepare an initial set of paperwork:
ORDER_RECEIVED→Trader App::PrepareInitialPaperwork( )
When the TraderApp component receives this action request, it might automatically generate and store a contract including pre-defined contact clauses. When the TraderApp component completes this task, it transmits the following action response to the control engine 900: OK(TraderApp::PrepareInitialPaperwork).

Another rule defines that when the managed business object is in state RECEIVED_ORDER and an OK(TraderApp::PrepareInitialPaperwork) is received, the control engine 900 will transition that object to state INITIAL_PAPERWORK_RECEIVED:
OK(TraderApp::PrepareInitialPaperwork)+ORDER_RECEIVED→INITIAL_PAPERWORK_RECEIVED

Similarly, the control engine 900 asks a ManagerApp component to customize the contract for the client and transitions the managed business object to state CLIENT_CUSTOMIZED after the ManagerApp transmits an action response indicating that the task is complete.

The control engine 900 then asks a LegalDept component to review the contract (e.g., to determine that the contract meets regulatory requirements. In this case, however, two rules might apply:
OK(LegalDept::Review)+CLIENT_CUSTOMIZED→APPROVED_BY_LEGAL
NotOK(LegalDept::Review)+CLIENT_CUSTOMIZED→LEGAL_PROBLEM
That is, the LegalDept may respond by indicating that the review is complete (and the contract is approved), in which case the control engine 900 transitions the managed business object to state APPROVED_BY_LEGAL. The LegalDept can also respond by indicating that the contract is not approved (i.e., NotOK). In this case, the control engine 900 transitions the managed business object to state LEGAL_PROBLEM. If the contract is approved by the LegalDept application (or if it revised and approved), the order is executed.

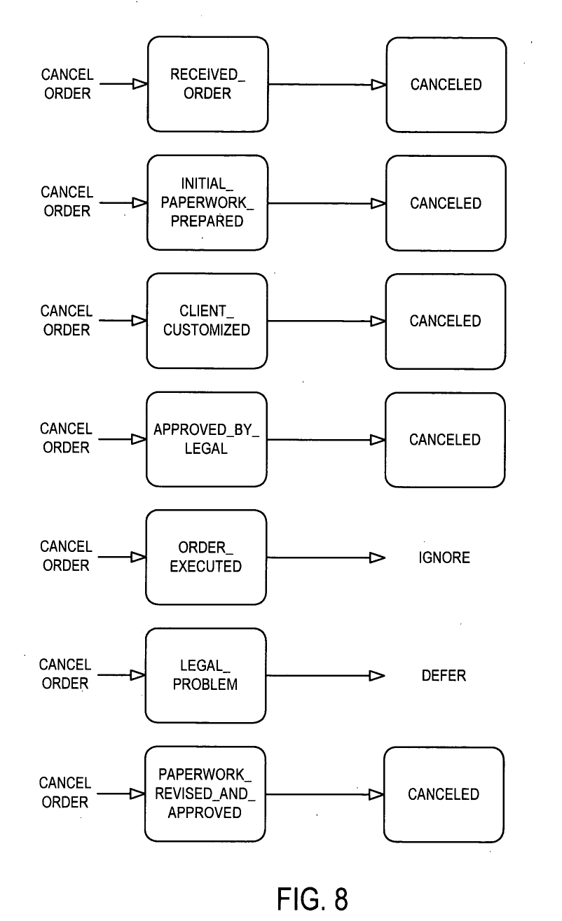

FIG. 8 illustrates additional state transitions according to an embodiment of the present invention. In particular, when a “Cancel Order” event notification is received by the control engine 900, the order may (or may not) be canceled based on the current state of the managed business object. For example, if the managed business object is in state INITIAL_PAPERWORK_PREPARED, the control engine 900 transition the managed business object to state CANCELED. In other cases, however, the control engine 900 will not honor the Cancel Order event notification (e.g., the event notification might be ignored or a decision might be deferred).

Control Engine

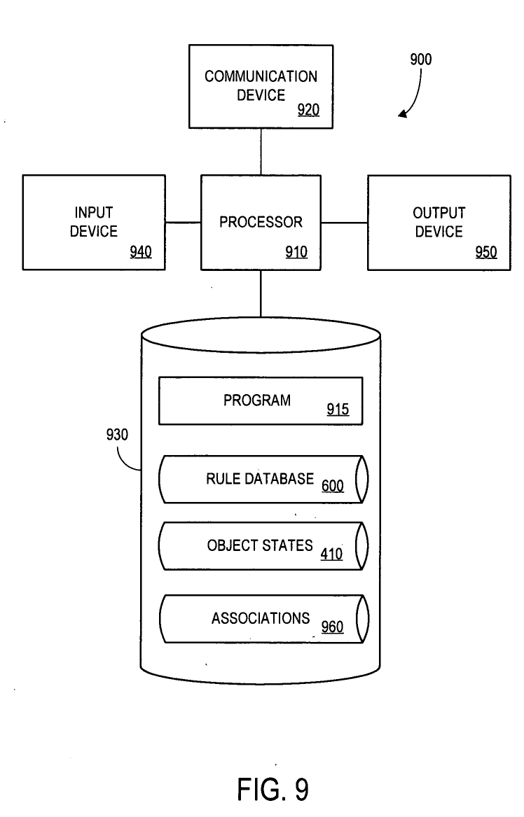

FIG. 9 is a block of a control engine 900 according to some embodiments of the present invention. The control engine 900 includes a processor 910, such as one or more INTEL® Pentium® processors, coupled to a communication device 920 configured to communicate via a communication network (not shown in FIG. 9). The communication device 920 may be used to communicate, for example, with one or more component application devices. Note that the control engine 900 may exchange and/or process information, for example, associated with glueware, middleware, a database, an Application Protocol Interface (API), and/or a message format.

An input device 940 (e.g., a computer mouse or keyboard) may be used to provide information to the control engine 900 (e.g., so that a rule can be defined). An output device 950 (e.g., a display device or printer) may be used to receive information from the control engine 900.

The processor 910 is also in communication with a storage device 930. The storage device 930 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 930 stores a program 915 for controlling the processor 910. The processor 910 performs instructions of the program 915. For example, the processor 910 may manage business object state transitions in accordance with any of the embodiments described herein.

As used herein, information may be “received” by or “transmitted” to, for example: (i) the control engine 900 from a component application; or (ii) a software application or module within the control engine 900 from another software application, module, or any other source.

As shown in FIG. 9, the storage device 930 also stores a rule database 600 (described with respect to FIG. 6) and object states 410 (described with respect to FIG. 4). According to some embodiments, the storage device 930 further stores associations 960. For example, the control engine 900 might associate one managed business object with one or more other managed business objects. Consider a contract business object that is associated with thirty cash flow business objects. In this way, an event notification associated with the contract business object might automatically transition the states of the thirty cash flow business objects (e.g., when the contract is canceled all of the cash flows could be automatically canceled).

Component Applications

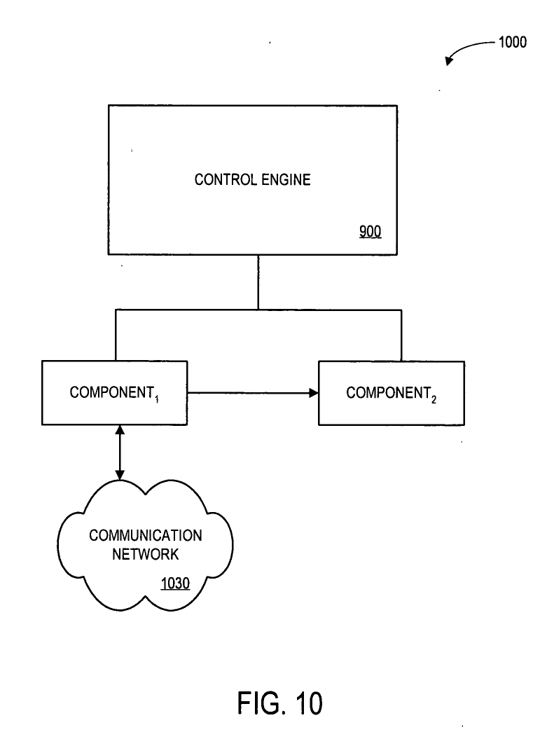

FIG. 10 is a block diagram overview of a system 1000 according to another embodiment of the present invention. As before, the control engine 900 exchanges information one a number of application components. Note that one component might not even be aware of the existence of another component (although it may be aware of the control engine 900, which in turn is aware of the other component). Moreover, an existing application might not need major modifications in order to interface with the control engine 900.

According to some embodiments, Component₁ can also transmit information directly to Component₂. For example, the control engine 900 might send an action request to Component₁ asking that a payment amount be re-calculated based on the current LIBOR rate. In this case, Component₁ accesses the current LIBOR rate via a communication network 1030. Moreover, Component₁ transmits the current LIBOR rate directly to Component₂ (which needs the information to respond to a future action request that will be generated by the control engine 900). One advantage of such an approach is that the information does not need to transmitted from Component₁ to the control engine 900 and then again from the control engine 900 to Component₂. Moreover, Component₂ might be able to start processing the information even before receiving an action request from the control engine 900.

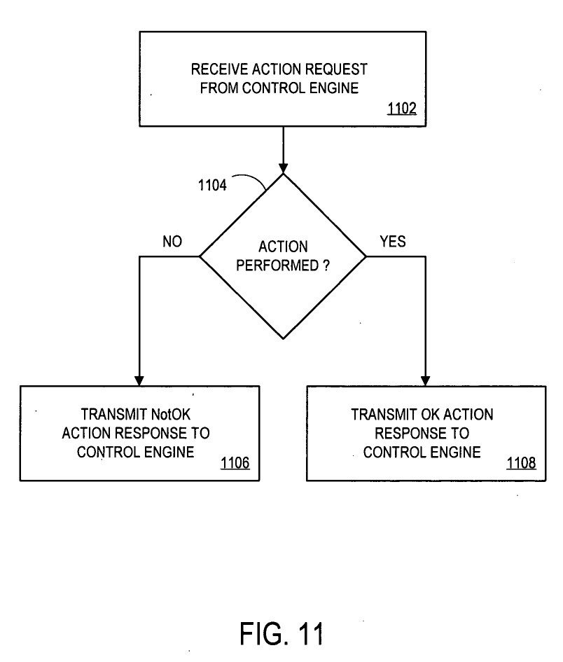

FIG. 11 is a flow chart of a component application method according to some embodiments of the present invention. At 1102, an action request is received from a control engine 900. The action request might, for example, ask the component application to execute a function, such as a function that posts an event notification or executes an action related to a managed object (e.g., to generate a report using a template).

If the action is not performed at 1104, a NotOK action response is transmitted to the control engine 900 at 1106. For example, a component application might not be able to perform an action because of a governmental regulation. If the action is performed at 1104, an OK action response is transmitted to the control engine 900 at 1108. According to some embodiments, a system may consistently execute actions (e.g., the system may obey a rule or generate an exception when there is no applicable rule).

Display

FIG. 12 illustrates an information display 1200 (e.g., a computer monitor) according to one embodiment of the present invention. In particular, the display 1200 provides a user interface to facilitate the definition of rules for a particular type of managed business object. The pre-conditions and post-conditions associated with existing rules are displayed, and a user can select to add a new rule by defining a new pre-condition and post-condition. The user may also select to “Associate” managed business objects, to “Save” the set of rules for the managed business object, to “Change Type” (e.g., to display rules associated with a different type of managed business object), and/or to “Cancel” the operation.

Thus, embodiments of the present invention may efficiently manage business objects. Moreover, the control application and related utilities may provide guaranteed, rule-based, properly ordered, consistent execution of functions by a set of independent components and the concomitant management of the states of a set of business objects, in response to potentially competing asynchronous events. In addition, the system is scalable (e.g., a large number of business objects may be managed) and the granularity of the objects and rules may be selected as appropriate.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Some embodiments have been described herein with respect to specific types of managed business objects, but the present invention may be used in connection with any other type of managed business object. Moreover, the specific rules provide herein are merely for illustration and embodiments may be associated with any type of rule for a managed business object.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method of processing a business transaction, comprising:
creating a managed business object associated with a plurality of pre-defined states;
receiving an event notification;
issuing an action request to a component application based on (i) a current state of the managed business object, (ii) the event notification, and (iii) a pre-defined rule;
receiving an action response from the component application; and
transitioning the state of the managed business object in accordance with the action response.

2. The method of claim 1, wherein the managed business object is associated with at least one of: (i) a contact, (ii) a long-term obligation, (iii) a cash flow, (iv) a business abstraction, or (v) a swap.

3. The method of claim 1, wherein the managed business object is associated with a unique identifier.

4. The method of claim 1, wherein a plurality of managed business objects co-exist.

5. The method of claim 4, wherein a first managed business object is associated with at least one other managed business object.

6. The method of claim 1, wherein at least one of the plurality of pre-defined states are associated with at least one of: (i) a contract status, (ii) a cash flow status, (iii) a rate fix, or (iv) an initial state.

7. The method of claim 1, wherein the event notification is associated with at least one of: (i) an asynchronous event, (ii) one of a plurality of potentially competing event notifications, (iii) a component application-generated event notification, (iv) a real-world condition, (v) financial market information, or (vi) an irrefutable event.

8. The method of claim 1, wherein there are a plurality of pre-defined rules.

9. The method of claim 1, wherein the pre-defined rule includes a pre-condition and a post-condition.

10. The method of claim 9, wherein the pre-condition is associated with at least one of: (i) receiving an event notification, (ii) receiving an action response, or (iii) a managed business object state transition.

11. The method of claim 9, wherein the post-condition is associated with at least one of: (i) transitioning a managed business object state, or (ii) issuing another action request.

12. The method of claim 1, wherein the action response indicates at least one of: (i) that an action has been completed, or (ii) that an action will not be completed.

13. The method of claim 1, wherein action requests are transmitted to and action responses are received from a plurality of independent component applications, and a first component application directly exchanges information with a second component application.

14. The method of claim 1, wherein said transitioning is performed by a control engine.

15. The method of claim 14, wherein the control engine is associated with at least one of: (i) glueware, (ii) middleware, (iii) a database, (iv) an application protocol interface, or (v) a message format.

16. A medium storing instructions adapted to be executed by a processor to perform a method to process a business transaction, said method comprising:
creating a managed business object associated with a plurality of pre-defined states;
receiving an event notification;
issuing an action request to a component application based on (i) a current state of the managed business object, (ii) the event notification, and (iii) a pre-defined rule;
receiving an action response from the component application; and
transitioning the state of the managed business object in accordance with the action response.

17. The medium of claim 16, wherein the managed business object is associated with at least one of: (i) a contact, (ii) a long-term obligation, (iii) a cash flow, (iv) a business abstraction, or (v) a swap.

18. The medium of claim 16, wherein the managed business object is associated with a globally unique identifier.

19. The medium of claim 16, wherein a plurality of managed business objects co-exist.

20. The medium of claim 19, wherein a first managed business object is associated with at least one other managed business object.

21. The medium of claim 16, wherein the event notification is associated with at least one of: (i) an asynchronous event, (ii) one of a plurality of potentially competing event notifications, (iii) a component application-generated event notification, (iv) a real-world condition, (v) financial market information, or (vi) an irrefutable event.

22. The medium of claim 16, wherein the pre-defined rule includes a pre-condition and a post-condition.

23. The medium of claim 22, wherein the pre-condition is associated with at least one of: (i) receiving an event notification, (ii) receiving an action response, or (iii) a managed business object state transition.

24. The medium of claim 22, wherein the post-condition is associated with at least one of: (i) transitioning a managed business object state, or (ii) issuing another action request.

25. The medium of claim 16, wherein the action response indicates at least one of: (i) that an action has been completed, or (ii) that an action will not be completed.

26. The medium of claim 16, wherein action requests are transmitted to and action responses are received from a plurality of independent component applications, and a first component application directly exchanges information with a second component application.

27. A control engine, comprising:
a processor; and
a storage device in communication with said processor and storing instructions adapted to be executed by said processor to:
create a managed business object associated with a plurality of pre-defined states,
receive an event notification,
issue an action request to a component application based on (i) a current state of the managed business object, (ii) the event notification, and (iii) a pre-defined rule,
receive an action response from the component application, and
transition the state of the managed business object in accordance with the action response.

28. The control engine of claim 27, further comprising:
an association database, wherein a first managed business object is associated with at least one other managed business object.

29. The control engine of claim 27, wherein the event notification is associated with at least one of: (i) an asynchronous event, (ii) one of a plurality of potentially competing event notifications, (iii) a component application-generated event notification, (iv) a real-world condition, (v) financial market information, or (vi) an irrefutable event.

30. The control engine of claim 27, further comprising:
a rule database storing entries associated with a plurality of rules, each entry including a pre-condition and an associated post-condition.

31. The control engine of claim 30, wherein at least one pre-condition is associated with at least one of: (i) receiving an event notification, (ii) receiving an action response, or (iii) a managed business object state transition.

32. The control engine of claim 30, wherein at least one post-condition associated with at least one of: (i) transitioning a managed business object state, or (ii) issuing another action request.

33. The control engine of claim 27, wherein the action response indicates at least one of: (i) that an action has been completed, or (ii) that an action will not be completed.

34. The control engine of claim 27, wherein action requests are transmitted to and action responses are received from a plurality of independent component applications, and a first component application directly exchanges information with a second component application.

35. A component application method, comprising:
receiving at a component application an action request from a control engine, the action request being issued by the control engine based on (i) a current state of a managed business object, (ii) an event notification received by the control engine, or (iii) a pre-defined rule;
performing an action in response to the action request; and
transmitting an action response to the control engine after the action is performed.

36. The method of claim 35, further comprising:
directly exchanging information with another component application.
